(19) United States
(12) Patent Application Publication
(10) Pub. No.: US 2013/0192414 A1
(43) Pub. Date: Aug. 1, 2013

(54) POWDER FORGED MEMBER, POWDER MIXTURE FOR POWDER FORGING, METHOD FOR PRODUCING POWDER FORGED MEMBER, AND FRACTURE SPLIT TYPE CONNECTING ROD USING THE SAME

(71) Applicant: HONDA MOTOR CO., LTD., Tokyo (JP)

(72) Inventors: Masaaki Sato, Takasago-shi (JP); Minoru Takada, Tokyo (JP); Kentaro Takada, Wako-shi (JP); Zenji Iida, Wako-shi (JP); Ryosuke Kogure, Wako-shi (JP)

(73) Assignee: HONDA MOTOR CO., LTD., Tokyo (JP)

(21) Appl. No.: 13/826,320

(22) Filed: Mar. 14, 2013

Related U.S. Application Data
(62) Division of application No. 12/307,662, filed on Jul. 2, 2009.

(30) Foreign Application Priority Data
Jul. 6, 2006 (JP) 2006-186927

(51) Int. Cl. F16C 7/02; B22F 3/17

(52) U.S. Cl. CPC F16C 7/02; B22F 3/17
USPC 74/579 R; 75/252; 419/28

(57) ABSTRACT

A member produced by powder forging which retains machinability and improved fatigue strength without having an increased hardness and can retain self conformability after fracture splitting; a powder mixture for powder forging; a process for producing a member by powder forging; and a fracture splitting connecting rod obtained from the member produced by powder forging. The member produced by powder forging is one obtained by preforming a powder mixture, subsequently sintering the preform, and forging the resultant sintered preform at a high temperature. The free-copper proportion in the sintered preform at the time when the forging is started is 10% or lower, and the member obtained through the forging has a composition containing, in terms of mass %, 0.2-0.4% C, 3-5% Cu, and up to 0.4% Mn (excluding 0), the remainder being iron and incidental impurities, and has a ferrite content of 40-90%.

### CROSS-REFERENCE TO RELATED APPLICATIONS

This is a divisional application of U.S. patent application Ser. No. 13/307,662, filed on Jul. 2, 2009, which is a 371 of International Application No. PCT/JP2007/063377, filed on Jul. 4, 2007, which claims the benefit of priority from the prior Japanese Patent Application No. 2006-186927 filed on Jul. 6, 2006, the entire contents of which are incorporated herein by references.

### TECHNICAL FIELD

The present invention relates to a powder forged member obtained by subjecting a powder mixture to preliminary compacting, then sintering the subjected compacted preform, and thereafter forging the obtained sintered preform, a powder mixture for powder forging, a method for producing the powder forged member, and a fracture split type connecting rod produced using the powder forged member.

### BACKGROUND ART

Conventionally, there has been widely carried out a powder forging method for subjecting a powder mixture to preliminary compacting, then sintering the subjected compacted preform, and thereafter forging the obtained sintered preform to produce machine parts. Examples of typical machine parts produced by the powder forging method include a connecting rod and a bearing race. Typically, the component composition of these machine parts using a pure iron-based powder contains C: 0.45 to 0.65% by mass (hereinafter, “% by mass” is merely represented as “%”), and Cu: 1.5 to 2% from the relationship of machinability and fatigue strength of products on machining after forging, and the like. A method for increasing the content of C or a method for increasing both the contents of C and Cu is generally required for weight saving or increase of fatigue strength of these machine parts. Although the fatigue strength of the part is increased in the methods for increasing the content of C, the hardness is also increased. This causes a problem that the service life of a tool on machining after forging is remarkably reduced to unfortunately increase the product cost. In addition, there is a disadvantage that the increased content of Cu causes the generation of cracks on forging easily.

A method for adding a reheating process and a cooling process after a forging process (see Patent Document 1), and a method for adding other alloy elements such as Ni and Mo (see Patent Document 2) are disclosed as another method for increasing the fatigue strength of the machine part. However, the former method causes the increase of processes and the latter method uses expensive alloys, increasing the cost of the part and increasing the hardness of the part as in the method for increasing the content of C. This causes a disadvantage that the machinability is reduced.

The above conventional methods decrease the toughness of the part with the increase of the hardness, causing the fracture surface to tend to become flat. When the part is produced using a fracture dividing method adopted in the connecting rod or the like, there is caused a particular problem of easily generating the positional shift of the part on assembling the part (i.e., reducing self-consistency).
Patent Document 1: Japanese Unexamined Patent Publication No. 61-117203
Patent Document 2: Japanese Unexamined Patent Publication No. 60-169501

### DISCLOSURE OF THE INVENTION

### Problems to be Solved by the Invention

It is an object of the present invention to provide a powder forged member in which fatigue strength is improved while securing its machinability without increasing its hardness, and self-consistency after fracture split can be secured, a method for producing the same, and a fracture split type connecting rod using the powder forged member.

### Means for Solving the Problems

In accordance with a first aspect of the present invention, a powder forged member has excellent machinability and fatigue strength, the powder forged member obtained by forging a sintered preform at a high temperature, the sintered preform formed by subjecting a powder mixture to preliminary compacting and thereafter sintering the subjected compacted preform, the sintered preform having a ratio of free Cu of 10% or less upon the start of the forging, the component composition of the powder forged member after the forging composed of, C: 0.2 to 0.4% by mass, Cu: 3 to 5% by mass and Mn: 0.5% by mass or less (excluding 0), and the balance iron with inevitable impurities, and the powder forged member having a ferrite ratio of 40 to 90%.

In the powder forged member, a relative density to theoretical density is preferably 97% or more.

In the powder forged member, it is preferable that a hardness is HRC 33 or less, and a partial pulsating tensile fatigue limit is 325 MPa or more.

It is preferable that the powder forged member contains at least one machinability-improving material in a total amount of 0.05 to 0.6% by mass, the machinability-improving material selected from the group consisting of MnS, MoS₂, B₂O₃ and BN.

In accordance with a second aspect of the present invention, a fracture split type connecting rod is produced by using the powder forged member of the first aspect.

In accordance with a third aspect of the present invention, a powder mixture is used as a raw material for the powder forged member of the first aspect, wherein a component composition except a lubricant is composed of, C: 0.1 to 0.5% by mass, Cu: 3 to 5% by mass, Mn: 0.4% by mass or less (excluding 0), O: 0.3% by mass or less and the balance iron with inevitable impurities.

It is preferable that the powder mixture for powder forging is obtained by adding a graphite powder, a copper powder and a lubricant into an iron-based powder composed of, C: less than 0.05% by mass, O: 0.3% by mass or less and the balance iron with inevitable impurities.

In accordance with a fourth aspect of the present invention, a powder mixture is used as a raw material for the powder forged member of the first aspect, wherein a component composition except a lubricant contains, C: 0.1 to 0.5% by mass, Cu: 3 to 5% by mass, Mn: 0.4% by mass or less (excluding 0), O: 0.3% by mass or less, and also at least one machinability-improving material in a total amount of 0.05 to 0.6% by mass, and the balance iron with inevitable impurities, the machinability-improving material selected from the group consisting of MnS, MoS₂, B₂O₃ and BN.

It is preferable that the powder mixture for powder forging is obtained by adding a graphite powder, a copper powder, at least one machinability-improving material selected from the group consisting of MnS, MoS₂, B₂O₃ and BN, and a lubricant into an iron-based powder composed of, C: less than 0.05% by mass, O: 0.3% by mass or less and the balance iron with inevitable impurities.

In accordance with a fifth aspect of the present invention, a method for producing the powder forged member having excellent machinability and fatigue strength of the first aspect, the method includes: a compacting and sintering step of subjecting the powder mixture for powder forging of the third aspect to preliminary compacting and thereafter sintering the subjected compacted preform to form a sintered perform; and a forging step of forging the sintered preform at a high temperature to form a powder forged member.

In accordance with a sixth aspect of the present invention, a method for producing the powder forged member having excellent machinability and fatigue strength of the first aspect includes: a compacting and sintering step of subjecting the powder mixture for powder forging of the fourth aspect to preliminary compacting and thereafter sintering the subjected compacted preform to form a sintered perform; and a forging step of forging the sintered preform at a high temperature to form a powder forged member.

### Effect of the Invention

The present invention increases the content of Cu as compared with that of the conventional one instead of decreasing the content of C of the powder forged member contrary to the conventional one, and limits the ratio of free Cu in the sintered preform upon the start of the forging. Thereby, since soft ferrite is increased by the reduction of the content of C to suppress the increase of hardness, the machinability can be secured and the toughness can be maintained to ensure self-consistency after fracture split. Furthermore, since the amount of diffusion of Cu into ferrite is increased by the increase of the content of Cu and the limit of the ratio of free Cu to promote solid solution strengthening, the fatigue strength is also drastically improved. The cracks of the powder forged member on forging can be prevented by limiting the ratio of free Cu.

### BRIEF DESCRIPTION OF THE DRAWINGS

FIG. 1(a) is a perspective view showing the shape and size of a test piece of a powder forged member used for fatigue test of Example, and FIG. 1(b) is a sectional view showing a section taken along line A-A.

FIG. 2 is a sectional view showing an applied state of a tensile load to a test piece of a powder forged member in fatigue test.

FIG. 3 is a graph showing the relationship between ratio of free Cu and fatigue limit.

FIG. 4 is a sectional view showing the microstructure of a powder forged member.

### BEST MODE FOR CARRYING OUT THE INVENTION

Hereinafter, the present invention will be described in further details.

### [Composition of Powder Forged Member]

First, the reason of limiting the composition of a powder forged member according to the present invention, that is, a component composition, structure, density and a ratio of free Cu in a sintered preform will be described.

### C: 0.2 to 0.4%

C is an indispensable element for ensuring the strength of a base steel. Conventionally, the hardness and strength of the base steel have been increased by increasing the content of C to decrease ferrite and increase perlite in the structure of the base steel. On the contrary, in the present invention, the content of C is conversely decreased to 0.4% or less in order to suppress the increase of the hardness of the base steel. However, since the strength of the base steel cannot be sufficiently ensured even if the content of Cu is increased when the content of C is excessively decreased, the content of C is set to 0.2% or more. Therefore, the content of C is set to 0.2 to 0.4%.

### Cu: 3 to 5%

Cu is an element which is dissolved in a ferrite phase in the structure of a base steel on heating for sintering and forging to form a solid solution to exhibit solid solution strengthening effect, and is partly precipitated on cooling to enhance the strength of the base steel. In the conventional product, Cu is almost used in an amount of about 2% of solid solution limit in the ferrite phase near the eutectoid temperature of Fe—C system. On the other hand, the solid solution limit of Cu in an austenite phase is about 8%. Cu of 3% or more can be dissolved sufficiently in the base steel to form a solid solution by increasing a heating temperature as compared with that of the conventional product and/or extending heating time. In the present invention, a larger amount of Cu than that of the conventional product is dissolved in the austenite phase to strengthen the solid solution of the ferrite phase generated in a cooling process. The content of Cu of less than 3.0% cannot exhibit the aimed solid solution strengthening effect sufficiently. On the other hand, the content of Cu exceeding 5.0% causes the free Cu to remain easily. The extension of heating time such as the extension of sintering time is required to limit the ratio of free Cu to 10% or less, and consequently the productivity is reduced. Therefore, the content of Cu is set to 3 to 5%, and preferably 3 to 4%.

### Mn: 0.5% or Less (Excluding 0)

Mn is an element which has the deoxidizing effect of the base steel and useful to increase hardenability and enhance the strength of the base steel. However, Mn has a high affinity to oxygen, and reacts with oxygen in atmosphere in a powder producing process or in a sintering process of a product subjected to preliminary compacting to easily produce an oxide. The content of Mn exceeding 0.5% makes it difficult to reduce a Mn oxide and remarkably reduce the quality characteristics of the powder forged member such as the reduction of density and strength caused by the Mn oxide. Therefore, the content of Mn is set to 0.5% or less (excluding 0), and preferably 0.4% or less (excluding 0).

### Balance: Iron and Inevitable Impurities

The powder forged member of the present invention may contain P, S, Si, O, N and other elements as inevitable impurities.

### Ratio of Free Cu: 10% or Less

As described above, Cu nearly two times that of the conventional product is used to strengthen the solid solution of the ferrite phase, and non-dissolved Cu (i.e., free Cu) easily remains in the base steel. Therefore, forging cracks may be generated by hot brittleness on forging. In a severe case, the possibility of the damage of the sintered preform is increased on handling between a forming sintering process and a forging process. Therefore, in the present invention, the ratio of free Cu in the sintered preform upon the start of the forging is set to 10% or less. Here, the ratio of free Cu, which means the ratio of non-dissolved Cu in the base steel, of the total amount of Cu added, can be quantitated by the following method. That is, the section of the sintered preform as a member to be measured is ground by paper and a buff, and is then etched by picric acid. Three positions having a range of 0.2 mm×0.3 mm are photographed by 400 magnifications using an optical microscope, and the total area of portions of copper color is measured by image processing. On the other hand, the total area of portions of copper color of a reference material is measured by the same method. As the reference material, there is used a product obtained by sintering a compacted product compacted in the same component compositions, shape and forming pressure as those of the member to be measured under the condition of 1000° C. for 20 minutes where Cu is not dissolved substantially in the base steel. The ratio of free Cu may be calculated using the following formula: Ratio of free Cu (%)=[total area of portions of Cu color of member to be measured]/[total area of portions of Cu color of reference material]×100.

### Ferrite Ratio: 40 to 90%

When the powder forged member has a ferrite ratio of less than 40%, the powder forged member has deficient toughness and insufficient self-consistency after fracture split. On the other hand, when the powder forged member has a ferrite ratio exceeding 90%, the powder forged member has excessively high toughness and large elongation, causing deformation on fracture split to deteriorate dimensional accuracy. Therefore, the ferrite ratio of the powder forged member is set to 40 to 90%.

### Relative Density to Theoretical Density: 97% or More

When the relative density to the theoretical density is less than 97%, the degree of reduction in the fatigue strength of the powder forged member becomes large. Therefore, the relative density to the theoretical density of the powder forged member is preferably 97% or more. When the relative density is set to 97% or more, the hardness of the powder forged member becomes HRC 33 or less and the partial pulsating tensile fatigue limit becomes 325 MPa or more. Therefore, there is provided a powder forged member having secured machinability and excellent fatigue strength.

### Machinability-Improving Material: Total Amount of 0.05 to 0.6%

A machinability-improving material may be added on preliminary compacting (i.e., to a powder mixture for powder forging) to improve the machinability of the powder forged member. As the machinability-improving material, for example, a powder composed of MnS, MoS₂, B₂O₃ or BN may be used. They may be used either singly or in the form of a combination of two or more members. When the amount of the machinability-improving material to be added is less than 0.05% in the total amount, the machinability-improving effect is not sufficiently obtained. On the other hand, when the amount of the machinability-improving material to be added exceeds 0.6%, an area occupied by an iron material is reduced, and nonmetal as the starting point of fatigue cracks is increased, showing a tendency of reduction in the fatigue strength. Therefore, the total amount of the machinability-improving material to be added is preferably 0.05 to 0.6% in the total amount.

### [Component Composition of Powder Mixture for Powder Forging]

Next, the reason of limiting the component composition of the powder mixture for powder forging (hereinafter, merely referred to as a “powder mixture”) will be described.

### C: 0.1 to 0.5%

It is necessary to adjust the content of C of the powder mixture in consideration of the amount of oxygen in the powder mixture and the kind of atmosphere gas on sintering so that the content of C of the powder forged member finally obtained is set to 0.2 to 0.4%. That is, when inactive gas atmosphere such as N₂ gas is used in the sintering process, C is oxidized and consumed by oxygen in the powder mixture and impurities oxygen in atmosphere gas. The content of C of the sintered preform (i.e., the powder forged member) is lower than that of the powder mixture. Thereby, the content of C of the powder mixture is adjusted to more than 0.2% and 0.5% or less which is higher than that of the powder forged member. On the other hand, when atmosphere gas having high carbon potential such as endothermic gas is used, carburization caused by atmosphere gas usually advances to more than the amount of oxidation consumption of C by oxygen in the powder mixture, and the content of C of the sintered preform (i.e., the powder forged member) becomes higher than that of the powder mixture. Thereby, the content of C of the powder mixture is adjusted to 0.1% or more and less than 0.4% which is lower than that of the powder forged member. Therefore, the content of C of the powder mixture may be set in the range of 0.1 to 0.5% while the change in the content of C is predicted in accordance with the content of oxygen of the powder mixture and the kind of sintering atmosphere gas.

### O: 0.3% or Less

The variation of the consumed C amount is also larger when the content of oxygen of the powder mixture is higher, and it becomes difficult to set the content of C of the powder forged member to the target of 0.2 to 0.4%. Thereby, the content of oxygen of the powder mixture is set to 0.3% or less.

### Other Components

Cu, Mn and the machinability-improving material are not consumed and produced on sintering as in C. The content of each of the components in the powder mixture is defined as the same as the content of each of the components in the powder forged member (although the value of the content of each of the components is extremely slightly changed by the increase and decrease of the amount of C on sintering in a precise sense, the value is within an ignorable range).

### [Method for Producing Powder Forged Member]

Next, a method for producing the powder forged member satisfying the above composition will be described.

First, the change of the content of C on sintering is predicted in accordance with the content of oxygen in an iron-based powder and the kind of sintering atmosphere gas. A graphite powder in which the content of C of the powder mixture is in the range of 0.1 to 0.5% so that the content of C after sintering is set to 0.2 to 0.4%, a copper powder in which the content of Cu is 3 to 5%, and the machinability-improving material of the total amount of 0.05 to 0.6% if necessary are added into an iron-based powder. A proper amount of a lubricant is further added thereto to produce a powder mixture. This powder mixture is subjected to preliminary compacting by a pressure compacting machine to produce a compacted preform.

When the iron-based powder used in producing the powder mixture is less compressibility, the density of the compacted preform on preliminary compacting is hardly increased. The inside of the sintered preform is oxidized during high temperature conveyance to the forging process after sintering, and a phenomenon in which the strength of the sintered preform is reduced by an oxide film occurs even if the sintered preform is forged. Therefore, in order to soften the iron-based powder and increase the density of the compacted preform to prevent the internal oxidation of the compacted preform, the content of C of the iron-based powder is set to be less than 0.05%, preferably 0.04% or less, and more preferably 0.02% or less.

Then, this compacted preform is sintered at a high temperature to produce a sintered preform. Here, referring to sintering condition, higher temperature and longer time are preferable because the diffusion of Cu advances and the amount of free Cu decreases as the temperature is higher or as time is longer. However, when the content of Cu is, for example, 4%, the ratio of free Cu can be set to 10% or less by sintering the preform at 1190° C. or more for 10 minutes.

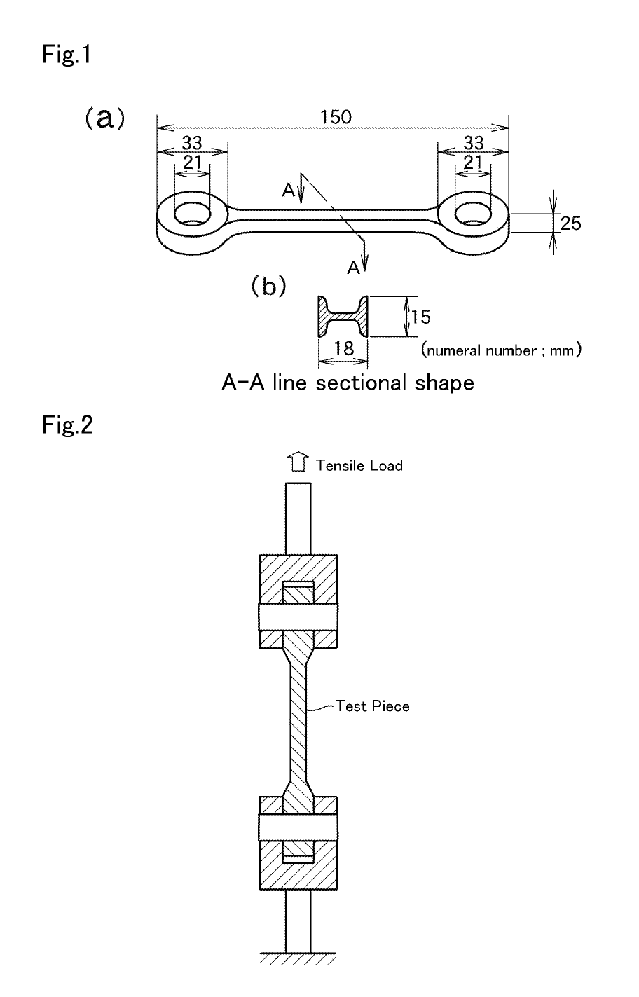

This sintered preform is immediately forged with a predetermined forging pressure at a high temperature without cooling the sintered preform to obtain a powder forged member. Higher forging pressure is preferable because the density of the powder forged member becomes higher and the strength is increased as the forging pressure is higher. However, when a connecting rod having a shape and size as shown in, for example, FIG. 1 is formed, the relative density to the theoretical density can be set to 97% or more by forging the preform with a pressure of 6.0 ton/cm² or more, resulting in the powder forged member having excellent machinability and fatigue strength.

Although the example immediately forging the preform using the temperature after sintering is described in the producing method, the preform may be once cooled after being sintered, and reheated to be forged. In this case, the preform is heated twice on sintering and forging and the heating time becomes longer inevitably. Thereby, even when the heating temperature is a temperature (about 1050° C. to about 1120° C.) further lower than the lower limit temperature (1190° C.), the ratio of free Cu can be set to 10% or less.

A fracture split type connecting rod produced using this powder forged member has reduced tool abrasion on machining, and suppress the increase in cost of parts, and has excellent fatigue strength and self-consistency on assembling after fracture split.

### Example 1

### Influence of Ratio of Free Cu

A graphite powder and a copper powder were added into a pure iron-based powder having a component composition shown in Table 1 so that the contents of C and Cu after being sintered were respectively 0.3% and 4%. Zinc stearate of 0.75% as a lubricant was further added thereto, and they were mixed for 30 minutes to produce a powder mixture. The powder mixture was subjected to preliminary compacting with a compacting surface pressure of 6 ton/cm² to produce a compacted preform.

TABLE 1

| | Components | | | | | | |
|---|---|---|---|---|---|---|---|
| | C | Mn | P | S | Si | O | N |
| Content (mass %) | 0.001 | 0.19 | 0.01 | 0.009 | 0.01 | 0.12 | 0.004 |

This compacted preform was dewaxed at 600° C. for 10 minutes under N₂ gas atmosphere, and was then sintered at various temperatures of 1110 to 1260° C. for 10 minutes to produce a plurality of sintered preforms. The ratio of free Cu of each of some sintered preforms was measured by using the method described in the above [Composition of Powder Forged Member]. The remaining sintered preforms were immediately forged with a forging pressure of 10 ton/cm² to produce test pieces of powder forged members imitating the shape of a connecting rod. Burr of each of the test pieces was removed, and the surface scale was removed by shot or the like to provide the test pieces to a pulsating tensile fatigue test. FIG. 1 shows the shape and size of each of the test pieces used for the fatigue test. FIG. 2 shows an applied state of a tensile load to each of the test pieces in the fatigue test.

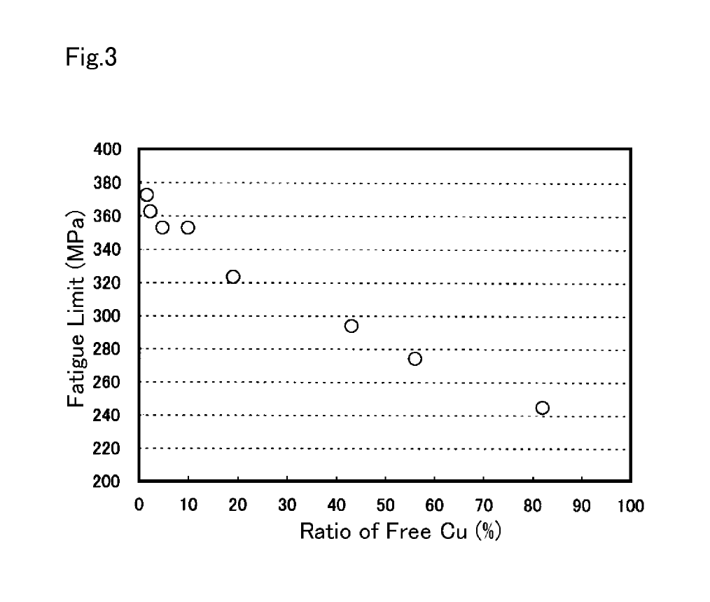

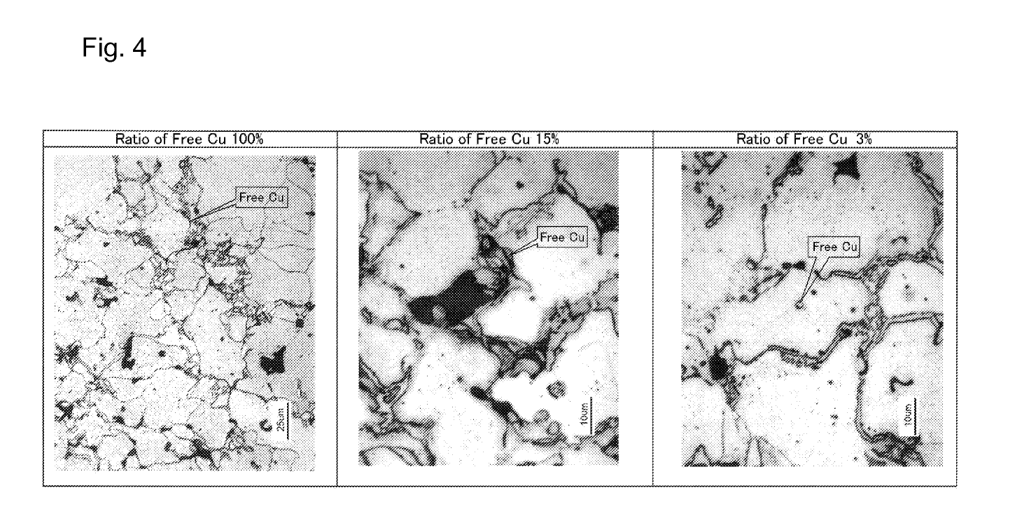

Table 2 and FIG. 3 show measurement and test results. As is apparent from Table 2 and FIG. 3, as the sintering temperature is higher, the ratio of free Cu decreases and the fatigue limit increases. When the sintering time is 10 minutes, the ratio of free Cu is 10% or less at the temperature of 1190° C. or more, and the fatigue limit of 325 MPa or more is obtained. FIG. 4 shows comparatively the cross-sectional microstructures of a reference material having a ratio of free Cu of 100%, a comparative material having the ratio of 15% and an inventive material of 3%. In FIG. 4, portions to which net hatching is applied have existing free Cu.

TABLE 2

| Test | Sintering | Ratio of | Fatigue | |
|---|---|---|---|---|
| pieces | temperature | free Cu | limit | |
| No. | (° C.) | (%) | (MPa) | Note |
| 101 | 1110 | 82 | 245 | Comparative |
| 102 | 1140 | 56 | 275 | example |
| 103 | 1170 | 43 | 294 | |
| 104 | 1180 | 19 | 324 | |
| 105 | 1190 | 9.8 | 353 | Inventive |
| 106 | 1200 | 4.6 | 353 | example |
| 107 | 1230 | 2.1 | 363 | |
| 108 | 1260 | 1.4 | 373 | |

In Inventive Example, the ferrite ratio of the powder forged member was about 70% at any sintering temperature.

### Example 2

### Influence of Contents of C and Cu

A graphite powder and a copper powder were added into a pure iron-based powder having the same component composition as that of Example 1 shown in Table 1 with the addition amounts of the graphite powder and copper powder variously changed so that the content of C and Cu after being forged were respectively 0.1 to 0.6% and 2 to 5% to produce a powder mixture. The powder mixture was subjected to preliminary compacting in the same condition as that of Example 1 described above to form a compacted preform. This compacted preform was dewaxed at 600° C. for 10 minutes under N₂ gas atmosphere, and was then sintered at 1120° C. for 30 minutes under N₂ gas atmosphere to produce sintered preforms. The sintered preforms were heated at 1050° C. for 30 minutes under N₂ gas atmosphere, and was then forged with a forging pressure of 10 ton/cm² to produce test pieces of powder forged members imitating the shape of the same connecting rod as that of Example 1 described above. These test pieces were subjected to a tensile fatigue test in the same condition as that of Example 1 described above, and the HRC hardness of each of the surfaces of the test pieces after being machined was measured.

Furthermore, the following test was performed in order to quantify self-consistency after fracture split. That is, a disk-shaped test piece of a powder forged member having a diameter of 90 mm×a thickness of 40 mm was produced in the same condition as in the above description. This was machined to produce a ring-shaped test piece having an outer diameter of 80 mm, an inner diameter of 40 mm×a thickness of 20 mm and having a V notch having a depth of 1 mm and an angle of 45 degrees on an inner ring diagonal line. This test piece was subjected to tensile fracture in the depth direction and right-angled direction of the notch. A real area including micro unevenness of the fracture surface was measured by using an optical three-dimensional measurement device (produced by GFMesstechnik Company, type: MicroCAD 3×4), and a ratio relative to a flat project area ignoring the unevenness (referred to as a “fracture split area ratio”) was calculated. Furthermore, the presence or absence of the shift of the engaged position of the fracture surface after fracture split was visually investigated.

Table 3 shows test results. The ratio of free Cu of each of the test pieces before being forged (upon the start of the forging) exceeded 10% in test piece No. 222 having the content of Cu exceeding 5%. However, the ratio was 10% or less in the other test pieces.

TABLE 3

| | Chemical | | | | | Fracture- | | |
|---|---|---|---|---|---|---|---|---|
| Test | composition | | | Fatigue | Ferrite | division | | |
| pieces | (mass %) | | Hardness | limit | ratio | area ratio | | |
| No. | C | Cu | (HRC) | (MPa) | (%) | (—) | Self-consistency | Note |
| 201 | 0.10 | 2.0 | 11.7 | 200 | 97 | 1.54 | X: deformation caused | Comparative |
| 202 | 0.10 | 2.5 | 12.8 | 209 | 97 | 1.53 | X: deformation caused | Example |
| 203 | 0.10 | 3.0 | 14.0 | 218 | 97 | 1.56 | X: deformation caused | |
| 204 | 0.10 | 3.5 | 15.2 | 227 | 96 | 1.55 | X: deformation caused | |
| 205 | 0.10 | 4.0 | 16.4 | 236 | 96 | 1.54 | X: deformation caused | |
| 206 | 0.10 | 4.5 | 17.5 | 245 | 97 | 1.52 | X: deformation caused | |
| 207 | 0.10 | 5.0 | 18.7 | 255 | 98 | 1.51 | X: deformation caused | |
| 208 | 0.20 | 2.0 | 16.2 | 235 | 83.6 | 1.54 | X: deformation caused | |
| 209 | 0.20 | 2.5 | 17.4 | 244 | 84.1 | 1.53 | X: deformation caused | |
| 210 | 0.20 | 3.0 | 18.5 | 307 | 84.6 | 1.51 | ◯ | Inventive |
| 211 | 0.20 | 3.5 | 19.7 | 316 | 85.1 | 1.50 | ◯ | Example |
| 212 | 0.20 | 4.0 | 20.9 | 325 | 85.6 | 1.49 | ◯ | |
| 213 | 0.20 | 4.5 | 22.1 | 334 | 86.1 | 1.48 | ◯ | |
| 214 | 0.20 | 5.0 | 23.2 | 341 | 86.6 | 1.46 | ◯ | |
| 215 | 0.30 | 2.0 | 20.7 | 270 | 66.9 | 1.46 | ◯ | Comparative |
| 216 | 0.30 | 2.5 | 21.9 | 280 | 67.4 | 1.45 | ◯ | Example |
| 217 | 0.30 | 3.0 | 23.1 | 340 | 67.9 | 1.47 | ◯ | Inventive |
| 218 | 0.30 | 3.5 | 24.3 | 346 | 68.4 | 1.45 | ◯ | Example |
| 219 | 0.30 | 4.0 | 25.4 | 352 | 68.9 | 1.44 | ◯ | |
| 220 | 0.30 | 4.5 | 26.6 | 357 | 69.4 | 1.43 | ◯ | |
| 221 | 0.30 | 5.0 | 27.8 | 360 | 69.9 | 1.42 | ◯ | |
| 222 | 0.30 | 6.0 | 28.0 | 306 | 70.1 | Not | Not measured | Comparative |
| | | | | | | measured | | Example |
| 223 | 0.40 | 2.0 | 25.3 | 315 | 50.2 | 1.44 | ◯ | |
| 224 | 0.40 | 2.5 | 26.4 | 360 | 50.7 | 1.43 | ◯ | |
| 225 | 0.40 | 3.0 | 27.6 | 363 | 51.2 | 1.42 | ◯ | Invention |
| 226 | 0.40 | 3.5 | 28.8 | 365 | 51.7 | 1.41 | ◯ | Example |
| 227 | 0.40 | 4.0 | 30.0 | 366 | 52.2 | 1.39 | ◯ | |
| 228 | 0.40 | 4.5 | 31.1 | 367 | 52.7 | 1.38 | ◯ | |
| 229 | 0.40 | 5.0 | 32.3 | 322 | 53.2 | 1.37 | ◯ | |
| 230 | 0.50 | 2.0 | 29.8 | 343 | 33.5 | 1.40 | ◯ | Comparative |
| 231 | 0.50 | 2.5 | 32.5 | 347 | 34 | 1.37 | ◯ | Example |
| 232 | 0.50 | 3.0 | 33.1 | 349 | 34.5 | 1.36 | X: shift caused | |
| 233 | 0.50 | 3.5 | 33.3 | 358 | 35 | 1.36 | X: shift caused | |
| 234 | 0.50 | 4.0 | 34.5 | 367 | 35.5 | 1.35 | X: shift caused | |
| 235 | 0.50 | 4.5 | 35.7 | 376 | 36 | 1.34 | X: shift caused | |
| 236 | 0.50 | 5.0 | 36.8 | 357 | 36.5 | 1.32 | X: shift caused | |
| 237 | 0.60 | 2.0 | 34.3 | 366 | 16.8 | 1.35 | X: shift caused | |
| 238 | 0.60 | 2.5 | 35.5 | 375 | 17.3 | 1.34 | X: shift caused | |
| 239 | 0.60 | 3.0 | 36.7 | 384 | 17.8 | 1.32 | X: shift caused | |
| 240 | 0.60 | 3.5 | 37.8 | 394 | 18.3 | 1.31 | X: shift caused | |
| 241 | 0.60 | 4.0 | 39.0 | 403 | 18.8 | 1.30 | X: shift caused | |
| 242 | 0.60 | 4.5 | 40.2 | 412 | 19.3 | 1.29 | X: shift caused | |
| 243 | 0.60 | 5.0 | 41.4 | 200 | 19.8 | 1.28 | X: shift caused | |

As shown in Table 3, the following is confirmed. Each of Inventive Examples in which the contents of C and Cu, the ferrite ratio and the ratio of free Cu were within the range defined in the present invention, which had hardness of HRC 33 or less, had no problem in machinability. Each of Inventive Examples had fatigue limit of 300 MPa or more, specifically 325 MPa or more, except some of Inventive Examples (test piece Nos. 210, 211). Inventive Examples had no shift observed in the fracture surface after fracture split and had no problem in self-consistency. Inventive Examples satisfied machinability, fatigue strength and self-consistency after fracture split simultaneously.

On the other hand, in Comparative Examples in which the component composition and/or the ferrite ratio fall/falls out of the range defined in the present invention, Comparative Examples, which have hardness of HRC 33 or less, have fatigue limit up to 300 MPa except some Comparative Examples (test piece Nos. 230, 231) and cause deformation due to elongation in fracture split to reduce dimensional accuracy (test piece Nos. 201 to 209). On the other hand, in Comparative Examples having fatigue limit of 300 MPa or more, the Comparative Examples have hardness exceeding HRC33 and have deteriorated machinability, and cause engaged positional shift of the fracture surface to cause a problem of self-consistency. Therefore, it turns out that it is very difficult to obtain the powder forged member simultaneously satisfying machinability, fatigue strength and self-consistency after fracture split.

As shown in Table 3, the fracture split area ratio can be used as the index representing self-consistency. When the fracture split area ratio is less than 1.37, the engaged shift of the fracture split surface occurs easily. On the other hand, when the fracture split area ratio exceeds 1.51, it turns out that the deformation due to elongation becomes remarkable and the dimensional accuracy is deteriorated.

### Example 3

### Influence of Relative Density

Next, there were produced test pieces of powder forged members having the same component composition (C: 0.3%, Cu: 3.5%) as that of test piece No. 218 of Example 2 in the same condition as that of Example 2 except that only a forging pressure was variously changed in the range of 2.5 to 10 ton/cm². The influence of the relative density of the powder forged member exerted on the fatigue limit was investigated. While the fatigue limit was measured, the HRB hardness of each of the test pieces was also measured. Table 4 shows test results.

TABLE 4

| Test | Forging | Relative | | |
|---|---|---|---|---|
| pieces | pressure | density | Hardness | Fatigue limit |
| No. | (ton/cm²) | (%) | (HRB) | (MPa) |
| 218 | 10 | 99 | 105.0 | 346 |
| 301 | 7.5 | 98 | 100.0 | 338 |
| 302 | 9.5 | 99 | 101.5 | 340 |
| 303 | 6.0 | 97 | 97.0 | 329 |
| 304 | 4.0 | 95 | 91.5 | 316 |
| 305 | 3.5 | 94 | 86.5 | 299 |
| 306 | 2.5 | 93 | 80.0 | 286 |

As shown in above Table 4, it is confirmed that the fatigue limit of 325 MPa or more could be ensured when the relative density to the theoretical density was 97% or more.

### Example 4

### Influence of Machinability-Improving Material

Next, test pieces of powder forged members having the same component composition (C: 0.3%, Cu: 3.5%) as that of the test piece No. 218 of Example 2 as in Example 3 were produced in the same manner as in Example 2 except that various machinability-improving materials were added with the addition amount thereof changed. The influence exerted on machinability was investigated. Referring to machinability, a thrust force was measured when a hole was formed from the surface of the test piece at the number of rotations of 200 rpm and the cutting speed of 0.12 mm/rev using an SKH drill having a diameter of 5 mm. This was used as the index of machinability. Table 5 shows the measurement results.

As is apparent from Table 5, the thrust force is reduced with the increase of the addition amount of the machinability-improving material to improve the machinability. However, when the addition amount of the machinability-improving material exceeds 0.6%, the large decrease trend of the fatigue limit is observed even in any machinability-improving agent.

TABLE 5

| | Machinability - | | | | |
|---|---|---|---|---|---|
| | improving material | | | | |
| | | Amount to be | | | Fatigue |
| Test pieces | | added | Thrust force | Hardness | limit |
| No. | Kinds | (mass %) | (N) | (HRC) | (MPa) |
| 218 | — | 0.0 | 770 | 24.3 | 346 |
| 401 | MnS | 0.2 | 765 | 24.8 | 351 |
| 402 | | 0.4 | 755 | 25.2 | 350 |
| 403 | | 0.6 | 750 | 26.2 | 335 |
| 404 | | 0.8 | 750 | 26.5 | 306 |
| 405 | MoS₂ | 0.8 | 750 | 25.5 | 308 |
| 406 | | 0.6 | 750 | 25.8 | 338 |
| 407 | B₂0₃ | 0.6 | 739 | 24.3 | 334 |
| 408 | | 0.8 | 744 | 25.4 | 299 |
| 409 | BN | 0.6 | 746 | 24.9 | 336 |
| 410 | | 0.8 | 749 | 26.3 | 316 |

### Example 5

### Influence of Oxygen Content of Powder Mixture

Next, the content of oxygen of a powder mixture was changed using an iron-based powder having different content of oxygen, and test pieces of powder forged members were produced in the same condition as in that of Embodiment 1 described above. The contents of C and Cu of the powder mixture after being forged were respectively set to 0.3% and 4% as the target, and the addition amount of graphite powder was set to 0.3%+(content % of oxygen of iron-based powder−0.05%)×3/4 to adjust the content of C. Referring to this test piece, the content of C and the fatigue limit were measured, and the influence of the content of oxygen of the powder mixture exerted thereon was investigated.

Table 6 shows test results. As shown in Table 6, when the content of oxygen of the iron-based powder (i.e., the powder mixture) was 0.3% or less (test piece Nos. 501 to 503), the content of C of the powder forged member was an approximate target content of C. However, when the content of oxygen of the iron-based powder (i.e., the powder mixture) exceeded 0.3% (test piece No. 504), it turned out that the content of C of the powder forged member was significantly shifted from the target content of C and fell out of the appropriate range (0.2 to 0.4%) of the content of C defined in the present invention to drastically reduce the fatigue strength.

TABLE 6

| | | | | | | | Powder forged member | | | |
|---|---|---|---|---|---|---|---|---|---|---|
| | | | | | | | Component | | | |
| Test | Chemical composition of | | | | | | composition | | Fatigue | |
| pieces | iron-based powder (mass %) | | | | | | (mass %) | | limit | |
| No. | C | Mn | P | S | Si | O | C | Cu | (MPa) | Note |
| 501 | 0.001 | 0.19 | 0.01 | 0.009 | 0.01 | 0.012 | 0.31 | 4.00 | 352 | Inventive |
| 502 | 0.001 | 0.18 | 0.01 | 0.009 | 0.01 | 0.020 | 0.29 | 4.05 | 353 | Example |
| 503 | 0.001 | 0.18 | 0.01 | 0.009 | 0.01 | 0.030 | 0.30 | 4.00 | 351 | |
| 504 | 0.001 | 0.19 | 0.01 | 0.009 | 0.01 | 0.040 | 0.15 | 3.95 | 267 | Comparative |
| | | | | | | | | | | Example |

### Example 6

### Influence of Content of C of Iron-Based Powder

Next, an iron-based powder having different content of C was used, and a powder mixture having the same component composition was produced by adjusting the addition amount of a graphite powder. Compacted preforms and test pieces of powder forged members were produced in the same condition as in Embodiment 1 described above. The contents of C and Cu after being forged were respectively set to 0.3% and 4% as the target. The densities of the compacted preform and powder forged member, and the fatigue limit of the powder forged member were measured.

Table 7 shows test results. As is apparent from Table 7, the decrease trend of the density of the compacted preform is shown with the increase of the content of C of the iron-based powder. When the content of C of the iron-based powder is 0.05% (test piece No. 604), it turns out that the fatigue strength is drastically reduced although the density of the powder forged member after being forged is almost the same as that of a case where the content of C is less than 0.05% (test piece No. 601 to 603).

TABLE 7

| | | | | | | | | Powder forged | | |
|---|---|---|---|---|---|---|---|---|---|---|
| | | | | | | | Compacted | member | | |
| Test | Component composition of | | | | | | perform | | Fatigue | |
| pieces | iron-based powder (mass %) | | | | | | Density | Density | limit | |
| No. | C | Mn | P | S | Si | O | (g/cm³) | (g/cm³) | (MPa) | Note |
| 601 | 0.001 | 0.19 | 0.01 | 0.009 | 0.01 | 0.12 | 7.05 | 7.83 | 353 | Inventive |
| 602 | 0.005 | 0.18 | 0.01 | 0.008 | 0.01 | 0.12 | 6.90 | 7.83 | 352 | Example |
| 603 | 0.02 | 0.19 | 0.01 | 0.009 | 0.01 | 0.13 | 6.60 | 7.81 | 335 | |
| 604 | 0.05 | 0.20 | 0.01 | 0.009 | 0.01 | 0.12 | 6.30 | 7.79 | 279 | Comparative |
| | | | | | | | | | | Example |

What is claimed is:

1. A fracture split type connecting rod having excellent machinability and fatigue strength,
the fracture split type connecting rod obtained by forging a sintered preform at a high temperature, the sintered preform formed by subjecting a powder mixture to preliminary compacting and thereafter sintering the subjected compacted preform,
the sintered preform having a ratio of free Cu of 10% or less upon the start of the forging,
the component composition of the fracture split type connecting rod after the forging composed of, C: 0.2 to 0.4% by mass, Cu: 3 to 5% by mass, Mn: 0.5% by mass or less excluding 0), and the balance iron with inevitable impurities, and
the fracture split type connecting rod having a ferrite ratio of 40 to 90%.

2. The fracture split type connecting rod having excellent machinability and fatigue strength according to claim 1, wherein a relative density to theoretical density is 97% or more.

3. The fracture split type connecting rod having excellent machinability and fatigue strength according to claim 2, wherein a hardness is HRC 33 or less, and a partial pulsating tensile fatigue limit is 325 MPa or more.

4. The fracture split type connecting rod having excellent machinability and fatigue strength according to any one of claims 1 to 3, wherein the fracture split type connecting rod contains at least one machinability-improving material in a total amount of 0.05 to 0.6% by mass, the machinability-improving material selected from the group consisting of MnS, MoS₂ and B₂O₃ and BN.

5. A powder mixture used as a raw material for a fracture split type connecting rod according to any one of claims 1 to 3, wherein a component composition except a lubricant is composed of, C: 0.1 to 0.5% by mass, Cu: 3 to 5% by mass, Mn: 0.4% by mass or less (excluding 0), O: 0.3% by mass or less and the balance iron with inevitable impurities.

6. The powder mixture for powder forging according to claim 5, wherein the powder mixture is obtained by adding a graphite powder, a copper powder and a lubricant into an iron-based powder composed of, C: less than 0.05% by mass, O: 0.3% by mass or less and the balance iron with inevitable impurities.

7. A powder mixture for powder forging used as a raw material for a fracture split type connecting rod according to claim 4, wherein a component composition except a lubricant contains, C: 0.1 to 0.5% by mass, Cu: 3 to 5% by mass, Mn: 0.4% by mass or less (excluding 0), O: 0.3% by mass or less, and at least one machinability-improving material in a total amount of 0.05 to 0.6% by mass, and the balance iron with inevitable impurities, the machinability-improving material selected from the group consisting of MnS, MoS₂ and B₂O₃ and BN.

8. The powder mixture for powder forging according to claim 7, wherein the powder mixture is obtained by adding a graphite powder, a copper powder, at least one machinability-improving material selected from the group consisting of MnS, MoS₂ and B₂O₃ and BN, and a lubricant into an iron-based powder composed of, C: less than 0.05% by mass or less, O: 0.3% by mass or less and the balance iron with inevitable impurities.

9. A method for producing a fracture split type connecting rod having excellent machinability and fatigue strength, the method comprising:
a compacting and sintering step of subjecting a powder mixture for powder forging according to claim 5 to preliminary compacting and thereafter sintering the subjected compacted preform to form a sintered perform; and
a forging step of forging the sintered preform at a high temperature to form a powder forged member.

10. A method for producing a fracture split type connecting rod having excellent machinability and fatigue strength, the method comprising:
a compacting and sintering step of subjecting a powder mixture for powder forging according to claim 7 to preliminary compacting and thereafter sintering the subjected compacted preform to form a sintered perform; and
a forging step of forging the sintered preform at a high temperature to form a powder forged member.

11. A method for producing a fracture split type connecting rod having excellent machinability and fatigue strength, the method comprising:
a compacting and sintering step of subjecting a powder mixture for powder forging according to claim 6 to preliminary compacting and thereafter sintering the subjected compacted preform to form a sintered perform; and
a forging step of forging the sintered preform at a high temperature to form a powder forged member.

12. A method for producing a fracture split type connecting rod having excellent machinability and fatigue strength, the method comprising:
a compacting and sintering step of subjecting a powder mixture for powder forging according to claim 8 to preliminary compacting and thereafter sintering the subjected compacted preform to form a sintered perform; and
a forging step of forging the sintered preform at a high temperature to form a powder forged member.
